(19) United States
(12) Patent Application Publication
(10) Pub. No.: US 2010/0130779 A1
(43) Pub. Date: May 27, 2010

(54) Volatile Group 2 Metal 1,3,5-Triazapentadienate Compounds

(75) Inventor: John Anthony Thomas Norman, Encinitas, CA (US)

Correspondence Address: AIR PRODUCTS AND CHEMICALS, INC.;PATENT DEPARTMENT, 7201 HAMILTON BOULEVARD, ALLENTOWN, PA, 181951501, US

(73) Assignee: Air Products and Chemicals, Inc., Allentown, PA (US)

(21) Appl. No.: 12/613,952

(22) Filed: Nov. 6, 2009

Related U.S. Application Data
(60) Provisional application No. 61/116,653, filed on Nov. 21, 2008.

(51) Int. Cl. C07F 3/00

(52) U.S. Cl. 564/1

(57) ABSTRACT

The present invention is directed to Group 2 metal 1,3,5-triazapentadiene compositions, such as bis(1,5-bisN,N′(methoxyethyl)-2,4-bis(dimethylamido)-1,3,5-triazapentadienate) barium; and the deposition of the metals of such metal ligand compositions by chemical vapor deposition, pulsed chemical vapor deposition or atomic layer deposition to produce Group 2 metal containing films, such as barium, strontium titanate ternary films or strontium titanate binary films for electronic materials device manufacturing.

### CROSS REFERENCE TO RELATED APPLICATIONS

The present patent application claims the benefit of U.S. Provisional Patent Application Ser. No. 61/116,653 filed Nov. 21, 2008.

### BACKGROUND OF THE INVENTION

The semiconductor fabrication industry continues to source metal containing precursors for chemical vapor deposition processes, including atomic layer deposition, for fabricating conformal metal containing films on substrates, such as; silicon, metal nitride, metal oxide and other metal-containing layers, using these metal-containing precursors. Barium and strontium containing precursors are especially sought after for the deposition of thin barium and strontium oxide containing thin films for advanced memory device manufacture. The prior art has attempted to provide precursors for these applications, as set forth below. However, none of the metal complexes in the prior art share the special characteristic of the complexes disclosed in this invention.

Relevant prior art includes:
Avent, A. G., M. R. Crimmin, M. S. Hill and P. B. Hitchcock (2005). “Dimerization of beta-Diketiminato Calcium Complexes through Dihapto-Acetylide Ligation.” Organometallics 24(6): 1184-1188.
Avent, A. G., M. R. Crimmin, M. S. Hill and P. B. Hitchcock (2006). “Reactivity of [HC{(C(Me)N(Dipp))}₂Ca{N(SiMe₃)₂}(THF)](Dipp=C₆H₃iPr₂-2,6) with C—H acids: Synthesis of heteroleptic calcium [eta]5-organometallics.” Journal of Organometallic Chemistry 691(6): 1242-1250.
Chisholm, M. H., J. C. Gallucci and K. Phomphrai (2004). “Well-Defined Calcium Initiators for Lactide Polymerization.” Inorg. Chem. 43(21): 6717-6725.
El-Kaderi, H. M. and M. J. W. Heeg, C. H.; (2004). “Sandwich Complexes of the Heavier Alkaline Earth Metals Containing 5-Diketiminato Ligand Sets.” Organometallics 23: 4995-5002.
Harder, S. (2002). “Homoleptic beta-Diketiminato Complexes of the Alkaline-Earth Metals Trends in the Series Mg, Ca, Sr, and Ba.” Organometallics 21(18): 3782-3787.
Millward, D. and T. Quick (2006). “Beta-diketiminate ligand sources and metal-containing compounds thereof, and systems and methods including same.” US2006/0292303A1.
Millward, D., S. Uhlenbrock and T. Quick (2006). “Unsymmetrical ligand sources, reduced symmetry metal-containing compounds, and systems and methods including same.” US2006/0292873A1.
Ruspic, C. and S. Harder (2007). “Big Ligands for Stabilization of Small Functionalities in Calcium Chemistry.” Inorg. Chem. 46(24): 10426-10433.
McGeachin, Canadian Journal of Chemistry, p. 1903, Vol. 46, 1968. Park, J. Org. Chem., 2005,70, 2075-2081.

### BRIEF SUMMARY OF THE INVENTION

The present invention is a metal ligand having at least one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and the metal is selected from the group consisting of magnesium, calcium, strontium, barium and radium.

The present invention is also a method of depositing a Group 2 metal on a semiconductor substrate comprising contacting the substrate with a metal ligand having at least one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and the metal is selected from the group consisting of magnesium, calcium, strontium, barium and radium.

### DETAILED DESCRIPTION OF THE INVENTION

In contrast to the prior art precursors described above, the compounds of the present invention have aliphatic side chains attached to the 1,5 position nitrogen atoms of a 1,3,5-triazapentadienate ligand functionalized with oxygen and nitrogen atoms. These groups, being anchored to the main body of the triazapentadinate ligand can then coordinate to the metal center to provide a large coordination sphere around the metal center.

This stabilizes the complex and permits monomeric metal complexes to form, especially in the case of barium, which has a tendency to form dimeric, tetrameric or polymeric complexes of lesser utility as precursors due to their high molecular weight. In the prior art mentioned above, no descriptions of group 2 triazapentadienate complexes are made. Indeed, these new molecules are absent from the chemical and patent literature, as is their use as volatile metal sources for chemical vapor deposition (“CVD”), atomic layer deposition (“ALD”) etc. In addition, those triazapentadienate metal compounds which are described do not contain coordinating oxygen or nitrogen groups in the organic groups attached to the terminal nitrogen atoms in positions 1 and 5 which can then coordinate to the metal center to provide a larger coordination sphere for the metal, as is particularly desirable in the case of barium and strontium compounds. This is similar to the situation found when diketimine ligands are used for Group 2 presursors, i.e., the groups attached to the diimine nitrogen atoms are simple alkyl groups or alkyl substituted aromatics with no coordinating nitrogen or oxygen atoms.

Copper (+1) and lithium (+1) 1,3,5-triazapentadienate compounds are described in Inorg. Chem., (47), 2008 where the groups attached to the terminal 1, 5 nitrogens are Si(Me)₃ bearing no oxygens or nitrogens. Manganese (+2), copper (+2), iron (+2), cobalt (+2) and lithium 1,3,5-triazapentadienes are described in Inorg. Chem. (47), 6692-6700 with hydrogen, Si(Me)₃, phenyl or 2,6 disopropylphenyl groups attached to the terminal 1,5 nitrogen atoms, but these goups bear no coordinating nitrogen or oxygen atoms. Nickel (+2) 1,4,5-triazapentadienyl compounds are described in Euro. J. Inorg. Chem, 2004, 267 where the terminal 1,5 nitrogen atoms are functionalized with Si(Me)₃ groups rather than organic groups bearing coordinating nitrogen or oxygen atoms. Palladium (+2) 1,3,5-triazapentadienyl compounds are described in Euro J. Inorg. Chem 2006, 3634 where the terminal 1,5 nitrogen atoms bear only hydrogen groups rather than organic groups bearing coordinating oxygen or nitrogen atoms. Fluorinated 1,3,5-triazapentadienate of the metals manganese, iron, cobalt, copper, nickel zinc and palladium are reported in Inorg. Chem. 2003 (42) 932-934 but only phenyl groups with no coordinating oxygen or nitrogen atoms are substituted onto the terminal 1,5-nitrogen atoms. Lithium potassium and sodium 1,3,5-triazapentadienyl compounds are described in Inorg. Chem. (42) 2596-2601 but the groups on the terminal 1,5 nitrogens are only phenyl with no oxygen or nitrogen atoms. A fluorinated 1,3,5-triazapentadienly mercury compound is reported in Organometallics, 2004, (23), 2281-2286, but only phenyl groups with no oxygen or nitrogen atoms are substituted on the 1,5 nitrogens. Highly fluorinated copper (+1) 1,3,5-triazapentadienyl compounds are described in Inorg. Chem. (45) 8859-8861 (2006), but the groupos on the 1,5 nitrogens are perfluorinated aryl or aryl functionalized with fluorine and trifluoromethyl groups with no coordinating oxygen or nitrogen groups. Silver 1,3,5-triazapentadienyl compounds are described in Inorg. Chem. (43) 7396-7402 (2004) but the groups on nitrogens 1 and 5 are 2,6-diisopropylphenyl with no oxygen or nitrogen substituents. Copper (+1) 1,3,5-triazapentadienyl compounds with only 2,6-diisopropyl phenyl groups on the 1,5 nitrogens are reported in Inorg. Chem. (43) 5786-5788 (2004).

For instance, in the case where the triazapentadiene ligand anion [Me₂NC(NCPh)NC(NPh)NMe₂]— would coordinate to barium, there are no coordinating oxygen atoms and no additional nitrogen atoms beyond the nitrogen atoms of the 1,3,5-triazapentediene ligand.

By contrast, the precursors of the present invention are based upon 1,3,5-traiazapentadiene ligands that provide an array of coordinating oxygen and nitrogen groups, which can wrap around and encapsulate the metal center. However, the group 2 metal complexes of this disclosure also include 1,3,5-triazapentadiene complexes, where the groups substituted on the 1,5-nitrogens contain no coordinating oxygen or nitrogen groups.

This invention is directed to metal containing polydentate 1,3,5-triazapentadienates and their solutions for vapor delivery by direct liquid injection, wherein the polydentate 1,3,5-triazapentadienates incorporate nitrogen or oxygen functionality by attaching them to the 1,5 nitrogens of the 1,3,5-triazapentadiene ligands, as metal coordinating side chains. It also includes a novel method of synthesizing 1,3,5-triazapentadiene ligands in high yield and high purity, using novel synthetic strategies for incorporating the coordinating side arm groups, which contain nitrogen and oxygen atoms.

Besides the 1,3,5-triazapentadiene ligands with coordinating side arms, other composition are described where sterically encumbered groups, such as t-butyl are substituted at the 1,5 nitrogen atoms. In this configuration, the resulting metal complexes, such as barium complexes will be forced to adopt novel coordination modes to the 1,3,5-triazapentadiene ligands resulting in monomeric volatile species. Additionally, the groups substituted onto the nitriles used in the ligand synthesis are chosen so that they contain oxygen or nitrogen groups, which will coordinate to and stabilize the barium center. The new 1,3,5-triazapentadiene ligands include, but are not limited to: Me₂NC(NCH₂CH(OMe)₂)NC(NHCH₂CH(OMe)₂)NMe₂; and Me₂NC(NCH₂CH₂OMe)NC(HNCH₂CH₂OMe)NMe₂.

The new metal complexes of this disclosure are characterized by 1,3,5-triazapentadienyl ligands, which contain additional coordinating atoms beyond the two 1,5 positioned nitrogen atoms of the 1,3,5-triazapentadienyl ligands, so as to provide a coordination sphere for the metal center. In this way, the entire coordination sphere is an integral part of the structure of the resulting metal complex. The polydentate metal 1,3,5-triazapentadienate complexes are selected from the group represented by the structures:

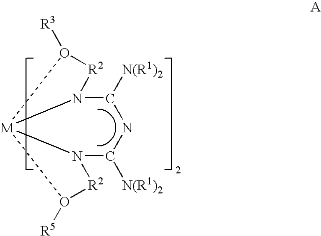

wherein M is a Group 2 metal selected from the group consisting of magnesium, calcium, strontium, barium, radium, preferably strontium and barium. A variety of organo groups may be employed as for example wherein R^{1-3,5} are individually selected from the group consisting of alkyl fluoroalkyl, silylalkyl, alkoxy, silylalkoxy and fluoroalkoxy having from 1 to 10 carbon atoms, preferably a group containing 1 to 6 carbon atoms, fluoroaryl, silylaryl, cycloaliphatic and aryl, having from 4 to 10 carbon atoms; preferably R¹⁻⁵ contains 2 or 3 carbon atoms, thus making a R five- or six-member coordinating ring to the metal center; In addition, groups R¹ can be connected to R², R³, or R⁵ to form rings.

The structure of bis(1,5-bisN,N′(methoxyethyl)-2,4-bis(dimethylamido)-1,3,5-triazapentadienate) barium, a specific example of the formulations illustrated by structure A, is shown below.

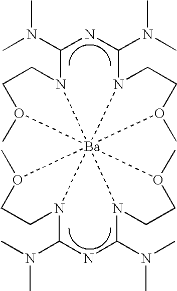

In addition, groups R², R³, R⁴ or R⁵ from one 1,3,5-triazapentadienly ligand can be connected to the same groups on the other 1,3,5-triazapentadienly ligand.

Additional nitrogen linkages can be contemplated as shown in B, below:

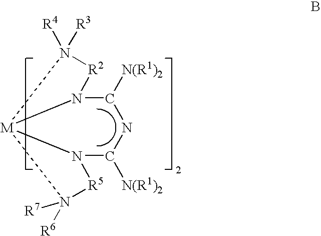

wherein M is a Group 2 metal selected from the group consisting of magnesium, calcium, strontium, barium and radium, preferably strontium and barium. A variety of organo groups may be employed, as for example, wherein R^{1,7} are selected from the groups consisting of alkyl fluoroalkyl, silylalkyl, alkoxy, silylalkoxy and fluoroalkoxy, having from 1 to 10 carbon atoms, preferably a group containing 1 to 6 carbon atoms, aryl, fluoroaryl, silylaryl, cycloaliphatic and aryl, having from 4 to 10 carbon atoms, preferably R^{2,5} contains 2 or 3 carbon atoms, thus making a five- or six-member coordinating ring to the metal center. In addition, group R¹ can be connected to R^{2,3,4,5,6}, to form ring structures. Also, R³, R⁴, R⁶ and R⁷ from one 1,3,5-triazapentadiene ligand can be connected to the same groups on the other 1,3,5-triazapentadiene ligand.

Alternate oxygen linkages can be contemplated as shown in C, below:

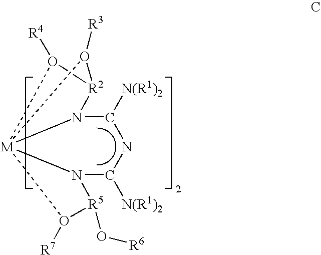

wherein M is a Group 2 metal selected from the group consisting of magnesium, calcium, strontium, barium, preferably strontium and barium. A variety of organo groups may be employed as for example wherein R^{1,3} is selected from the group consisting of hydrogen, alkyl, and fluoroalkyl having from 1 to 10 carbon atoms, preferably a group containing 1 to 6 carbon atoms, cycloaliphatic and aryl, having from 4 to 10 carbon atoms; R² is selected from the group consisting of hydrogen, alkyl and alkoxy having from 1 to 10 carbon atoms, nitro, acyl and aryl having from 6 to 10 carbon atoms. R¹, R² and R³ can also be connected to form rings. R^{4,7} are individually selected from the group consisting of alkyl and fluoroalkyl having from 1 to 10 carbon atoms, and aryl having from 6 to 10 carbon atoms, preferably R^{4,7} contains 2 or 3 carbon atoms, thus making a five- or six-member coordinating ring to the metal center; R^{5,6,8,9} are individually selected from the group consisting of alkyl and fluoroalkyl having from 1 to 10 carbon atoms, cycloaliphatic and aryl having from 4 to 10 carbon atoms, and they can be connected to form a ring containing carbon, oxygen, or nitrogen atoms. groups R⁴, R⁵ or R⁶ can be connected to R⁷, R⁸ or R⁹ of the same diketimine ligand or to R⁴, R⁵, R⁶, R⁷, R⁸ or R⁹ of the other diketimine ligand. Similarly, R⁶, R⁷ or R⁹ can be connected to the same groups in the other ligand. In addition, R¹ can also be attached to R², R⁷, R⁸ and R⁹; R³ can be attached to R², R⁴, R⁵ or R⁶.

Separate ether linkages to carbon are contemplated for the chelating oxygens, as shown in D, below:

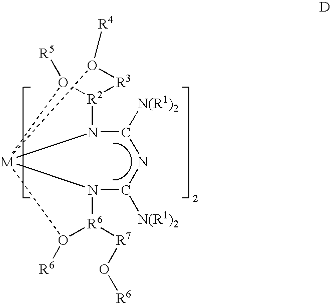

wherein M is a Group 2 metal selected from the group consisting of magnesium, calcium, strontium, barium, radium, preferably strontium and barium. A variety of organo groups may be employed as for example wherein R^{1-,9} is selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms and groups R¹ to R⁹ can be connected together to form rings. Additionally, groups R¹-R⁹ can be connected any of the corresponding groups in the other 1,3,5-triazapentadiene ligand found in the metal complex

Heterocyclic chelating complexes similar to epoxides are contemplated in E, as shown below:

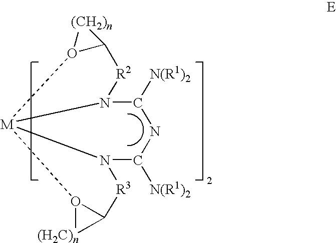

wherein M is a Group 2 metal selected from the group consisting of magnesium, calcium, strontium, barium or radium, preferably strontium and barium. A variety of organo groups may be employed as for example wherein R¹⁻³ is selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms preferably R³ contains 1 or 2 carbon atoms, thus making a five- or six-member coordinating ring to the metal center; n=4, 5, 6.

In addition, group R¹ to R⁴ can be connected to together to form ring structures. In addition, any of these same groups can be connected to their counterparts in the other 1,3,5-triazpentadienyl ligand of the metal complex

Ligands can be bound not only to the metal center but to each ligand through an organic linkage, such as shown in F, below:

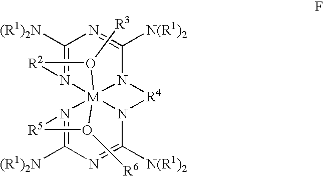

wherein M is a Group 2 metal selected from the group consisting of magnesium, calcium, strontium, barium, radium preferably strontium and barium. A variety of organo groups may be employed as for example wherein R¹⁻⁶ is selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms, preferably R⁵ contains 2 or carbon atoms, thus making a five- or six-member coordinating ring to the metal center.

Alternatively, R⁴ can also contain ether or amine groups, which can also coordinate to the metal center. In addition, groups R¹, R², R³, R⁵ and R⁶ can also be connected.

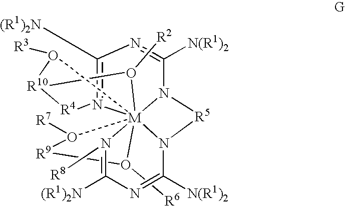

wherein M is a Group 2 metal selected from the group consisting of magnesium, calcium, strontium, barium, radium, preferably strontium and barium. A variety of organo groups may be employed as for example wherein R¹⁻⁹ is selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms, preferably groups R⁴/R¹⁰ and R⁸/R⁹ constitutes 2 or 3 carbon atoms, thus making a five- or six-member coordinating ring to the metal center.

Additionally, R⁵ can also contain ether or amine groups which can also coordinate to the metal center. R¹, R², R³, R⁴, R⁶, R⁷, R⁸, R⁹ and R¹⁹ can also be connected together.

Ligands that have additional nitrogen chelating functionality, as well as organic linkage between the ligands is contemplated, as in H, below:

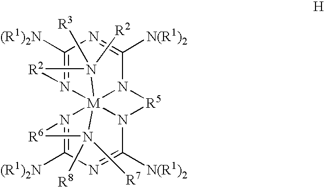

wherein M is a Group 2 metal selected from the group consisting of magnesium, calcium, strontium, barium, radium preferably strontium and barium. A variety of organo groups may be employed as for example wherein R¹⁻⁸ is selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms; preferably R^{4,6} contains 2 or 3 carbon atoms, thus making a five- or six-member coordinating ring to the metal center.

Alternatively, R⁵ can also contain ether or amine groups which can also coordinate to the metal center. R¹, R², R³, R⁴, R⁶, R⁷, R⁸ can be connected.

Further nitrogen chelating functionality beyond what is previously described are envisioned in I, below:

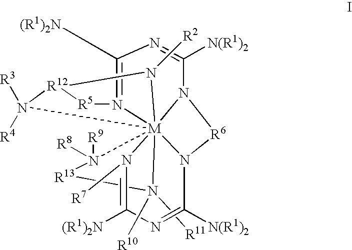

wherein M is a Group 2 metal selected from the group consisting of magnesium, calcium, strontium, barium, radium, preferably strontium and barium. A variety of organo groups may be employed, as for example, wherein R¹⁻¹¹ are selected from the group consisting of alkyl, fluoroalkyl, silylalkyl, alkoxy, silylalkoxy and fluoroalkoxy having from 1 to 10 carbon atoms, preferably a group containing 1 to 6 carbon atoms, aryl, fluoroaryl, silylaryl, cycloaliphatic and aryl, having from 4 to 10 carbon atoms. Preferably R groups 5/12, 7/17 constitute a 2 or 3 carbon atom linkage, thus making a five- or six-member coordinating ring to the metal center

Alternatively, R⁶ can also contain ether or amine groups, which can also coordinate to the metal center.

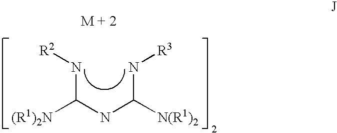

where R¹ can be alkyl, fluoroalkyl, ary, fluoroalkyl, alkoxy, fluoroalkoxy, alkyl amine. R² is a bulky alkyl group, such as; t-butyl, which contains no metal coordinating atoms, such as; nitrogen or oxygen. R³ can also be a bulky group, which contains no metal coordinating atoms, such as; nitrogen or oxygen; or alternatively, it can be hydrogen or an alkyl or aryl group, which does contain a coordinating group, such as; oxygen or nitrogen, as exemplified in the compounds A through I, above. In the structures(J) the 1,3,5-triazapentadiene ligand may coordinate ‘sideways’, whereby the metal center, such as barium, is positioned between two ligand anions, such that it is above the plane of one anion and below the plane of the other.

In addition to the above complexes, while not wishing to be bound by theory, mixed barium complexes can also be made, where two different 1,3,5-triazapentadiene anions are coordinated to a metal center or where one 1,3,5-triazapentadiene anion and one other organic or inorganic anion coordinate to barium to make a complete complex. Examples of such alternative anions include, but are not limited to, diketiminates, beta-diketonates, acetates, ketoiminates, alkoxides, amides, hydrides, beta-ketoesters, amidinates, guanidinates, cyclopentadienyl, cyanide, isocyanide, formate, oxalate, malonate, phenoxide, thiolate, sulfide, nitrate, alkyl, silylalkyl, fluoroalkyl, aryl, alkoxide, hydride.

Several advantages can be achieved through these metal-containing polydentate 1,3,5-triazapentadiene as precursors for chemical vapor deposition or atomic layer deposition, and these include:
an ability to form reactive complexes in good yield;
an ability to form monomeric complexes, particularly strontium and barium complexes, coordinated with one kind of ligand, thus achieving higher vapor pressure than that of the known strontium and barium precursors (the known strontium and barium precursors are either polymeric complexes with lower vapor pressure or monomeric compounds with two different ligands having thermal stability issues);
an ability to form highly conformal metal oxide thin films suited for use in microelectronic devices;
an ability to enhance the surface reaction between the metal-containing polydentate 1,3,5-triazapentadiene and the surface of a substrate due to the high chemical reactivity of the complexes; and,
an ability to tune the physical and chemical properties of these metal-containing polydentate 1,3,5-triazapentadiene via a change in the substituent groups.

Additionally, metal complexes can also be made by coordinating two different carefully chosen 1,3,5-triazapentadiene anions to a metal center, such as barium, such that the two ligands experience an optimal ‘fit’ or ‘interlock’ with each other and around the metal in such a way as to provide an adequate coordination sphere to create a stable monomeric complex.

1. A metal ligand having at least one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and the metal is selected from the group consisting of magnesium, calcium, strontium, barium and radium.

2. The metal ligand of claim 1 having two 1,3,5-triazapentadienate ligands, each having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal.

3. The metal ligand of claim 1 wherein each aliphatic side chain is functionalized with an oxygen or a nitrogen that coordinates with the metal.

4. The metal ligand of claim 1 wherein the metal is selected from the group consisting of barium and strontium.

5. The metal ligand of claim 1 having one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and a second ligand coordinating with the metal selected from the group consisting of diketiminates, beta-diketonates, acetates, ketoiminates, alkoxides, amides, hydrides, beta-ketoesters, amidinates, guanidinates, cyclopentadienyl, cyanide, isocyanide, formate, oxalate, malonate, phenoxide, thiolate, sulfide, nitrate, alkyl, silylalkyl, fluoroalkyl, aryl, alkoxide and hydride.

6. The metal ligand of claim 1 having one 1,3,5-triazapentadienate ligand having aliphatic side chains on the 1- and 5-nitrogen atoms, where at least one aliphatic side chain is functionalized with an oxygen or nitrogen atom that coordinates with the metal, a second 1,3,5-triazapentadienate ligand having aliphatic side chains on the 1- and 5-nitrogen atoms, where at least one aliphatic side chain is functionalized with an oxygen or nitrogen atom that coordinates with the metal, wherein each 1,3,5-triazapentadienate ligand is different from the other and the 1- and 5-nitrogen atoms of each 1,3,5-triazapentadienate ligand coordinate with the metal.

7. The metal ligand of claim 1 having the structure: 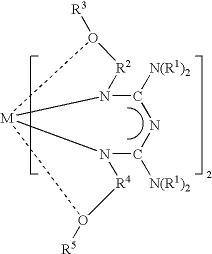
wherein M is a Group 2 metal selected from the group consisting of magnesium, calcium, strontium, barium, radium, preferably strontium and barium: wherein R¹⁻⁵ are individually selected from the group consisting of alkyl, fluoroalkyl, silylalkyl, alkoxy, silylalkoxy and fluoroalkoxy, having from 1 to 10 carbon atoms, aryl, fluoroaryl, silylaryl, cycloaliphatic and aryl, having from 4 to 10 carbon atoms; or group R¹ can be connected to R², R³, R⁴ or R⁵ to form rings.

8. The metal ligand of claim 1 having the structure: 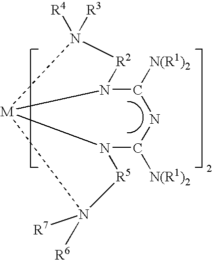
wherein M is a Group 2 metal selected from the group consisting of magnesium, calcium, strontium, barium and radium; wherein R¹⁻⁷ are selected from the groups consisting of alkyl, fluoroalkyl, silylalkyl, alkoxy, silylalkoxy and fluoroalkoxy, having from 1 to 10 carbon atoms, fluoroaryl, silylaryl, cycloaliphatic and aryl, having from 4 to 10 carbon atoms; or group R¹, can be connected to R^{2,3,4,5,6} to form ring structures.

9. The metal ligand of claim 1 having the structure: 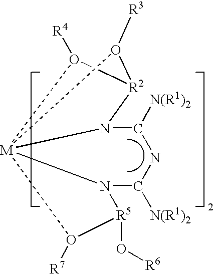
wherein M is a Group 2 metal selected from the group consisting of magnesium, calcium, strontium, barium; wherein R^{1,3} is selected from the group consisting of hydrogen, alkyl, and fluoroalkyl having from 1 to 10 carbon atoms, cycloaliphatic and aryl, having from 4 to 10 carbon atoms; R² is selected from the group consisting of hydrogen, alkyl and alkoxy having from 1 to 10 carbon atoms, nitro, acyl and aryl having from 6 to 10 carbon atoms; or. R¹, R² and R³ are connected to form rings; R^{4,7} are individually selected from the group consisting of alkyl and fluoroalkyl having from 1 to 10 carbon atoms, and aryl having from 6 to 10 carbon atoms; R^{5,6,8,9} are individually selected from the group consisting of alkyl and fluoroalkyl having from 1 to 10 carbon atoms, cycloaliphatic and aryl having from 4 to 10 carbon atoms, and they can be connected to form a ring containing carbon, oxygen, or nitrogen atoms.

10. The metal ligand of claim 1 having the structure: 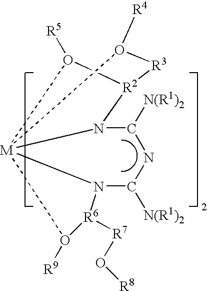
wherein M is a Group 2 metal selected from the group consisting of magnesium, calcium, strontium, barium, radium; R¹⁻⁹ are individually selected from the group consisting of alkyl, fluoroalkyl, silylalkyl, alkoxy, silylalkoxy and fluoroalkoxy having from 1 to 10 carbon atoms, fluoroaryl, silylaryl, cycloaliphatic and aryl, having from 4 to 10 carbon atoms and groups R¹ to R⁹ can be connected together to form rings or groups R¹-R⁹ can be connected to any of their corresponding groups in the other 1,3,5-triazapentadiene ligand found in the metal complex.

11. The metal ligand of claim 1 having the structure: 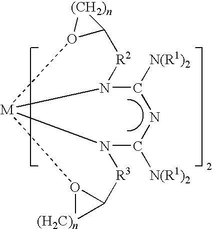
wherein M is a Group 2 metal selected from the group consisting of magnesium, calcium, strontium, barium or radium; R¹⁻³ is selected from the group consisting of alkyl, fluoroalkyl, silylalkyl, alkoxy, silylalkoxy, fluoroalkoxy having from 1 to 10 carbon atoms, fluoroaryl, silylaryl, cycloaliphatic and aryl, having from 4 to 10 carbon atoms or group R¹ to R⁴ can be connected to together to form ring structures, or any of these same groups can be connected to their counterparts in the other 1,3,5-triazpentadienyl ligand of the metal complex.

12. The metal ligand of claim 1 having the structure: 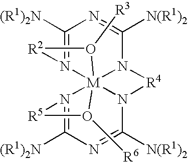
wherein M is a Group 2 metal selected from the group consisting of magnesium, calcium, strontium, barium, R¹⁻⁶ is selected from the group consisting of alkyl, fluoroalkyl, silylalkyl, alkoxy, silylalkoxy and fluoroalkoxy having from 1 to 10 carbon atoms, fluoroaryl, silylaryl, cycloaliphatic and aryl, having from 4 to 10 carbon atoms.

13. The metal ligand of claim 1 having the structure: 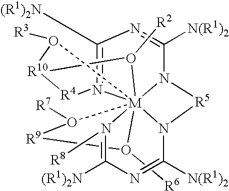
wherein M is a Group 2 metal selected from the group consisting of magnesium, calcium, strontium, barium, radium, R¹⁻⁹ is selected from the group consisting of alkyl, fluoroalkyl, silylalkyl, alkoxy, silylalkoxy and fluoroalkoxy having from 1 to 10 carbon atoms, fluoroaryl, silylaryl, cycloaliphatic and aryl, having from 4 to 10 carbon atoms or R⁵ can also contain ether or amine groups, which can also coordinate to the metal center and R¹, R², R³, R⁴, R⁶, R⁷, R⁸, R⁹ and R¹⁰ can be connected together.

14. A method of depositing a Group 2 metal on a semiconductor substrate comprising contacting the substrate with a metal ligand having at least one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and the metal is selected from the group consisting of magnesium, calcium, strontium, barium and radium.

15. The method of claim 14 wherein the metal ligand has two 1,3,5-triazapentadienate ligands, each having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal.

16. The method of claim 15 wherein each aliphatic side chain is functionalized with an oxygen or a nitrogen that coordinates with the metal.

17. The method of claim 14 wherein the metal is selected from the group consisting of barium and strontium.

18. The method of claim 14 wherein the deposition is conducted with one 1,3,5-triazapentadienate ligand having aliphatic side chains on the 1- and 5-nitrogen atoms, where at least one aliphatic side chain is functionalized with an oxygen or nitrogen atom that coordinates with the metal, the 1- and 5-nitrogen atoms coordinate with the metal and a second ligand coordinating with the metal selected from the group consisting of diketiminates, beta-diketonates, acetates, ketoiminates, alkoxides, amides, hydrides, beta-ketoesters, amidinates, guanidinates, cyclopentadienyl, cyanide, isocyanide, formate, oxalate, malonate, phenoxide, thiolate, sulfide, nitrate, alkyl, silylalkyl, fluoroalkyl, aryl, alkoxide and hydride.

19. The method of claim 14 wherein the 1,3,5-triazapentadienate ligand has aliphatic side chains on the 1- and 5-nitrogen atoms, where at least one aliphatic side chain is functionalized with an oxygen or nitrogen atom that coordinates with the metal, a second 1,3,5-triazapentadienate ligand having aliphatic side chains on the 1- and 5-nitrogen atoms, where at least one aliphatic side chain is functionalized with an oxygen or nitrogen atom that coordinates with the metal, wherein each 1,3,5-triazapentadienate ligand is different from the other and the 1- and 5-nitrogen atoms of each 1,3,5-triazapentadienate ligand coordinate with the metal.

20. A method of claim 14 wherein the 1,3,5-triazapentadienate ligand has the structure: 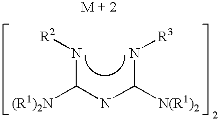
wherein R¹ is C₁-C₁₀ alkyl, R² and R³ independently are aliphatic side chains on the 1- and 5-nitrogen atoms.

21. The method of claim 20 wherein at least one of the aliphatic side chains contains coordinating atoms of oxygen or nitrogen.

22. The method of claim 20 wherein the aliphatic side chains are individually selected from the group consisting of t-butyl, t-amyl, and neopentyl.

23. The method of claim 20 wherein the group bonded to the 1- and 5-nitrogen atoms are individually selected from the group consisting of hydrogen, alkyl and aryl, which contain a coordinating group of oxygen or nitrogen.

24. The method of claim 20 wherein each R¹ is independently selected from the group consisting of alkyl, fluoroalkyl, aryl, fluoroalkyl, alkoxy, fluoroalkoxy, alkyl amine.

25. The method of claim 14 using an oxidant selected from the group consisting of oxygen, ozone, nitrous oxide, and water vapor.

26. The method of claim 25 including either direct or remote plasma activation.

27. The metal ligand of claim 1 comprised of two different 1,3,5-triazapentadiene anions coordinated to a metal center.

28. The metal ligand of claim 1 having one 1,3,5-triazapentadiene anion and one other organic or inorganic anion coordinate to the metal.

29. The metal ligand of claim 28 wherein the one other organic or inorganic anion is selected from the group consisting of diketiminates, beta-diketonates, acetates, ketoiminates, alkoxides, amides, hydrides, beta-ketoesters, amidinates, guanidinates, cyclopentadienyl, cyanide, isocyanide, formate, oxalate, malonate, phenoxide, thiolate, sulfide, nitrate, alkyl, silylalkyl, fluoroalkyl, aryl, alkoxide, and hydride.

30. The metal ligand of claim 1 in a solvent.

31. The metal ligand of claim 1 having the structure as following: 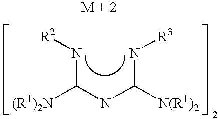
wherein R¹ is C₁-C₁₀ alkyl, R² and R³ independently are aliphatic side chains on the 1- and 5-nitrogen atoms, and the ligand may coordinate sideways, whereby the metal is positioned between two ligand anions, such that it is above the plane of one anion and below the plane of the other.
